(19) United States
(12) Patent Application Publication
(10) Pub. No.: US 2013/0143122 A1
(43) Pub. Date: Jun. 6, 2013

(54) CARBON-TREATED CATHODE MATERIAL USABLE FOR BATTERIES AND METHOD OF MAKING SAME

(71) Applicant: JEN-CHIN HUANG, NEW TAIPEI CITY (TW)

(72) Inventor: JEN-CHIN HUANG, NEW TAIPEI CITY (TW)

(73) Assignees: GOLDEN CROWN NEW ENERGY (HK) LIMITED, Hong Kong (HK); SUZHOU GOLDEN CROWN NEW ENERGY CO., LTD., CHANGSHU CITY (CN)

(21) Appl. No.: 13/363,077

(22) Filed: Jan. 31, 2012

(30) Foreign Application Priority Data
Dec. 2, 2011 (CN) 201110395186.1

(51) Int. Cl. H01M 4/38; B05D 7/00; H01M 4/525; B05D 5/12; B82Y 30/00

(52) U.S. Cl. 429/221; 429/231.8; 427/77; 427/215; 977/773

(57) ABSTRACT

A method for preparing a cathode material is provided, which includes: providing particles of a cathode material; coating a carbon layer onto the particles of the cathode material, in which the carbon layer is formed of a carbon-containing compound; and mixing the carbon-containing compound with the particles at a temperature equal to or lower than 0° C. According to the method, the lithium ferrous phosphate powder does not agglomerate in the carbon coating process, and the carbon-coated particles have slightly increased volumes so that the nano-lithium ferrous phosphate material maintains its nano size after being coated with carbon.

### CROSS-REFERENCE TO RELATED PATENT APPLICATIONS

This application claims priority to and the benefit of, pursuant to 35 U.S.C. §119(a), Chinese patent application No. 201110395186.1, filed Dec. 2, 2011, entitled “CARBON-TREATED CATHODE MATERIAL USABLE FOR BATTERIES AND METHOD OF MAKING SAME”, by Jen-Chin Huang, the content of which is incorporated herein by reference in its entirety.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference were individually incorporated by reference.

### FIELD OF THE INVENTION

The present invention relates generally to a cathode material for batteries, and more particularly, to a carbon-treated cathode material, such as lithium ferrous phosphate (LiFePO₄), for lithium ion batteries used in power tools, consumer electronic, and electric vehicles, and method of making same.

### BACKGROUND OF THE INVENTION

A lithium ion battery is a rechargeable and dischargeable battery in which lithium ions (Li⁺) can be intercalated in and deintercalated from positive electrode (cathode) and negative electrode (anode) materials. A cathode thereof is generally formed by a lithium intercalated compound, such as lithium cobalt oxide (LiCoO₂) and lithium nickel oxide (LiNiO₂) having layered crystal structures, and lithium manganese oxide (LiMn₂O₄) having a spinel crystal structure. During charging, Li⁺ is deintercalated from the cathode, passes through an electrolyte, and is then intercalated in the anode. At the same time, electrons are supplied from an external circuit to the anode for charge compensation. In contrast, during discharging, Li⁺ is deintercalated from the anode, passes through the electrolyte, and is then intercalated in the cathode material.

U.S. Pat. No. 6,855,273 discloses an alkaline and transition metal complex oxide material, such as lithium ferrous phosphate (LiFePO₄), coated with carbon, and a preparation method thereof. The preparation method includes, during or after synthesizing the alkaline and transition metal complex oxide material such as LiFePO₄, pyrolytically depositing a carbonaceous material onto the surface of the material to form a non-powder coating layer. Although the method significantly improves the conductivity of the materials such as LiFePO₄, the preparation method is expensive and easily generates impurities, the quality of the product likely deteriorates, and the coating effect for the nano-powder is limited.

Therefore, a heretofore unaddressed need exists in the art to address the aforementioned deficiencies and inadequacies.

### SUMMARY OF THE INVENTION

In one aspect, the present invention provides a cathode material, including particles coated with carbon, in which a ratio of a size of the carbon-coated particles of the cathode material to a size of uncoated particles of the cathode material is in a range of about 1.01:1-1.5:1. Preferably, the ratio ranges from about 1.01:1 to about 1.3:1, more preferably, from about 1.01:1 to about 1.2:1, and most preferably, from about 1.01:1 to about 1.1:1. Theoretically, the size of the particles is increased about 1-2% according to the present invention. However, with increasing deposition of carbon, the size can be generally increased by 10%, and may be increased by about 30-50% at the utmost. In this case, the nano size can still be maintained.

In one embodiment, the shapes of the particles prior to and after carbon coating remain unchanged. In another embodiment, the shapes of the particles prior to and after carbon coating are both spherical shapes.

In another aspect, the present invention provides a method of coating a cathode material (e.g. a nano-size material), such as a lithium ferrous phosphate material, with carbon. The lithium ferrous phosphate powder does not agglomerate in the carbon coating process, and the carbon-coated particles have slightly increased volumes so that the nano-lithium ferrous phosphate material maintains its nano size after being coated with carbon. The method solves the technical problems in the conventional methods, especially the technical problems of agglomeration, greatly increased volume, decreased specific surface area, and even degradation of the size to micron scale of nano-lithium ferrous phosphate after being coated with carbon.

In one embodiment, the method includes: providing particles of a cathode material; coating a carbon layer onto the particles of the cathode material, and a mixing and/or milling step of mixing a carbon-containing (carbonaceous) compound with the nano particles at a temperature lower than or equal to about 0° C. Preferably, the mixing temperature is in a range of about −30° C.-0° C. Preferably, the carbon-containing compound is milled prior to the mixing step, so that the particle size is below 5 μm, and may be as small as 1 μm; and the milling temperature is about 0° C. or below. At this temperature, the dryness and hardness of the carbon-containing compound are maintained, and the carbon-containing compound is milled mainly for the purpose of refining the particles so that the carbon-containing compound can be easily mixed with the lithium ferrous phosphate powder uniformly.

In some embodiments, after the low-temperature mixing step, the mixture is heated. In one embodiment, the heating step includes: heating the mixture in a vacuum environment at a temperate of about 300° C. or higher for a time period of about 2-8 hours. The heating step removes moisture and other liquid and gaseous impurities in the carbon-containing compound so as to make the carbon-containing compound in a liquid state or a gel state. Preferably, the temperature of the heating step is about 300° C. This step is provided to remove the impurities such as moisture in the carbon-containing compound so that lithium ferrous phosphate does not react with the impurities in the carbon coating process, thereby preventing from the decrease of purity.

In one embodiment, after the heating step, the method further includes a carbon coating and sintering step: sintering the heated mixture at a temperature in a range of about 500-1000° C. for a time period of about 4-24 hours in an inert atmosphere (nitrogen or argon) with a pressure in a range of about 400-500 kPa to vaporize the carbon of the carbon-containing compound so as to coat the carbon onto the surface of the lithium ferrous phosphate crystal. The pressure of about 400-500 kPa is provided for the purpose that the vaporized carbon resides in the sintering device and adheres to the surface of the lithium ferrous phosphate powder without fleeing, and after cooling, the vaporized carbon turns into solid state carbon coated onto the surface of the lithium ferrous phosphate powder.

In one embodiment, after the sintering step, the method further includes a milling step: for example, ball-milling the cooled cathode material powder to disperse the agglomerated and caked particles.

According to the present invention, the carbon-containing compound is selected from, but is not limited to, liquid or solid perylene and a derivative thereof, a polyhydroxylic compound, a polymer, cellulose, starch and an ester and an ether thereof, and all of the carbon-containing compounds as described in Chinese Patent Application No. 200780040835.8. In one embodiment, a carbon-containing compound having a general formula (CₓH_{2y}O_{y})ₙ is preferred, in which n≧1. Because the non-carbon elements in (CₓH_{2y}O_{y})ₙ is hydrogen (H) and oxygen (O), and the proportion thereof is the same as that in water molecules, impurities other than carbon can be easily removed.

Preferably, the carbon-containing compound is glucose (C₆H₁₂O₆), sucrose, maltose (C₁₂H₂₂O₁₁) or starch ((C₆H₁₀O₅)ₙ) (n≧1). In one embodiment, a mass percentage of the carbon of the carbon-containing compound in the cathode material is in a range of about 0.5%-5%. The nano particles of the cathode material may be LiFePO₄, LiMPO₄ with a transition metal M substituting for iron (Fe), or modified LiFePO₄ compound, such as the compound as described in the U.S. Pat. No. 6,514,640.

By using the method of the present invention, the final product obtained includes carbon-coated nano particles of the cathode material such as a lithium ferrous phosphate (LiFePO₄) powder, in which the morphology of the powder particles remains unchanged due to, for example, evenly coated carbon onto the surface of the lithium ferrous phosphate powder. For example, when the carbon coating method of the present invention is implemented onto spherical powder particles of lithium ferrous phosphate, the carbon-coated powder particles maintain the spherical shapes. Furthermore, the size of the powder particle is slightly increased, by about 50% at the most, and generally about 30% or less, for example, about 1-30%. Preferably, by coating carbon onto lithium ferrous phosphate (LiFePO₄) with an average particle size distribution of D₅₀ of about 100-600 nm, the carbon-coated powder particles would be obtained with an average particle size distribution of D₅₀ of about 500-700 nm.

In yet another aspect, the present invention relates to a method of preparing a cathode material. In one embodiment, the method includes providing particles of the cathode material and a carbon-containing compound; milling and mixing the carbon-containing compound and the particles at a first temperature for a first period of time to form a mixture; heating the mixture at a second temperature for a second period of time in a vacuum environment; sintering the heated mixture at a third temperature for a third period of time in an inert atmosphere so as to vaporize the carbon of the carbon-containing compound, thereby coating the vaporized carbon on the particles to form carbon-coated particles; and milling the carbon-coated particles. In one embodiment, the milling and mixing step is performed by milling the carbon-containing compound; mixing the particles with the carbon-containing compound while milling the carbon-containing compound; and milling the mixed carbon-containing compound and particles.

In one embodiment, the first temperature is in a range of about −30° C.-0° C., and the first period of time is about 0.2-1.5 hours. The second temperature is in a range of about 60-500° C. and the second period of time is about 2-8 hours. The third temperature is in a range of about 500-1000° C. and the third period of time is about 4-24 hours. In one embodiment, the pressure in the inert atmosphere is in a range of about 400-500 kPa.

In one embodiment, the particles of the cathode material comprise lithium ferrous phosphate (LiFePO₄).

In one embodiment, the carbon-containing compound has a chemical formula (CₓH_{2y}O_{y})ₙ, wherein n≧1.

In a further aspect, the present invention relates to a cathode material prepared according to the above method.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention.

Wherever possible, the same reference numbers are used throughout the drawings to refer to the same or like elements of an embodiment, and wherein:

FIG. 1 shows a flow chart of a method for preparing carbon-coated nano-lithium ferrous phosphate (lithium ferrous phosphate) according to one embodiment of the present invention;

FIG. 2 shows an SEM diagram of lithium ferrous phosphate powders prior to carbon-coating according to one embodiment of the present invention; and

FIG. 3 shows an SEM diagram of carbon-coated lithium ferrous phosphate powders according to one embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

The embodiments of the present invention described below include particles and nano particles, and the size of the particles are generally indicated by the average particle size distribution of Dₙ, where n is a percentage number between 0 and 100. Specifically, the average particle size distribution of Dₙ is defined as the cumulative undersize distribution of the relative amount of the particles at or below a particular size. For example, “particles having an average particle size distribution of D₅₀ of about 500 nm” means that 50% of the amount of the particles has the size at or below 500 nanometers.

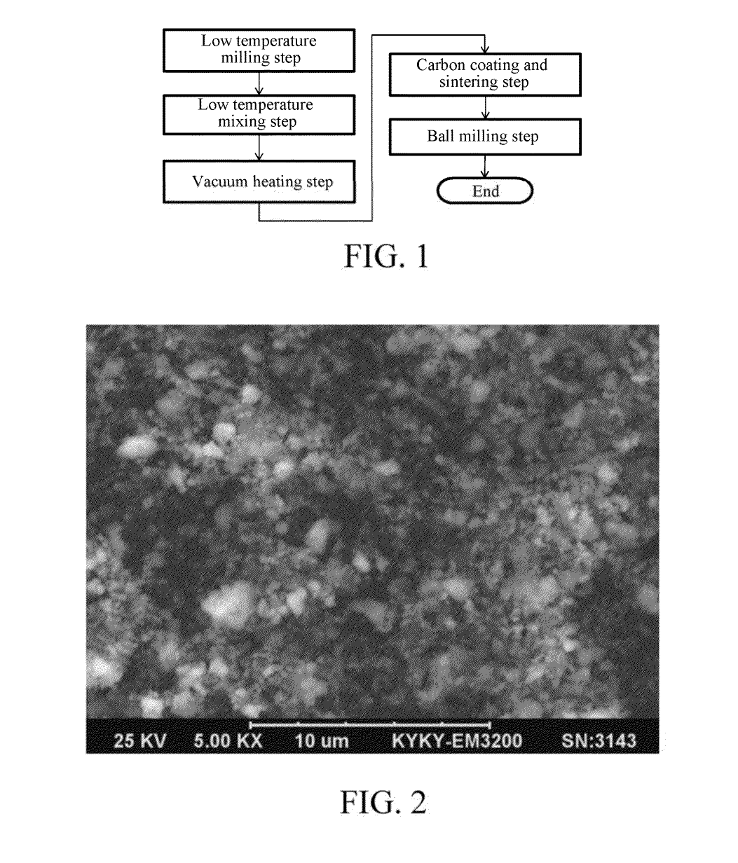

The description will be made as to the embodiments of the present invention in conjunction with the accompanying drawings in FIGS. 1-3. In accordance with the purposes of this invention, as embodied and broadly described herein, this invention, in one aspect, relates to a cathode material treated with carbon usable for batteries and methods of preparing the same.

Referring to FIG. 1, a method of preparing a cathode material containing carbon-coated nano-lithium ferrous phosphate (lithium ferrous phosphate) is shown according to one embodiment of the present invention. In one embodiment, the method includes providing particles of the cathode material and a carbon-containing compound. In one embodiment, the particles of the cathode material comprise lithium ferrous phosphate (LiFePO₄). The carbon-containing compound has a chemical formula (CₓH_{2y}O_{y})ₙ, wherein n≧1.

The method also includes milling and mixing the carbon-containing compound and the particles at a first temperature for a first period of time to form a mixture, which is corresponding to the low temperature mixing step and the low temperature milling step shown in FIG. 1. The milling and mixing step in one embodiment is performed by milling the carbon-containing compound, mixing the particles with the carbon-containing compound while milling the carbon-containing compound, and milling the mixed carbon-containing compound and particles.

Further, the method includes heating the mixture at a second temperature for a second period of time in a vacuum environment, and sintering the heated mixture at a third temperature for a third period of time in an inert atmosphere so as to vaporize the carbon of the carbon-containing compound, thereby coating the vaporized carbon on the particles to form carbon-coated particles. The heating and sintering steps are respectively corresponding to the vacuum heating step and carbon-coating and sintering step shown in FIG. 1. In one embodiment, the pressure in the inert atmosphere is in a range of about 400-500 kPa.

In one embodiment, the first temperature is in a range of about −30° C.-0° C., and the first period of time is about 0.2-1.5 hours. The second temperature is in a range of about 60-500° C. and the second period of time is about 2-8 hours. The third temperature is in a range of about 500-1000° C. and the third period of time is about 4-24 hours.

In addition, the method also includes milling the carbon-coated particles, which in one embodiment, is a ball-milling step as shown in FIG. 1.

The specific embodiments of the present invention is described below with reference to examples; however, the exemplary descriptions are provided only for illustrating the implementation of the present invention with a limited number of examples, and are not intended to limit the claims of the present invention.

### EXAMPLE 1

1.1 Raw materials:

1.1.1 Spherical powder particles of lithium ferrous phosphate (LiFePO₄) having an average particle size of D₅₀ of about 500 nm, about 157 g, and

1.1.2 Glucose (C₆H₁₂O₆), about 3.8 g.

1.2 Preparation method:

1.2.1 Milling and mixing step: the carbon-containing compound was milled in a ball milling machine at a temperature of about −10° C., and then the lithium ferrous phosphate powder is added, milled and mixed for a time period of about 45 min while maintaining frozen, thereby forming a mixture thereof

1.2.2 Heating, carbon coating and sintering step: the mixture was heated to a temperature of about 300° C. for a time period of about 8 hours in a vacuum environment to remove moisture and other liquid and gaseous impurities in the glucose. Then nitrogen was introduced, and the heated mixture was sintered at a temperature of about 700° C. for a time period of about 10 hours in a nitrogen atmosphere with a pressure controlled to be in the range of about 400-500 kPa to vaporize the carbon so as to coat the carbon onto the surface of the lithium ferrous phosphate crystal.

1.2.3 Ball milling step: the cooled carbon-coated lithium ferrous phosphate powder was ball milled to disperse the agglomerated and caked particles.

1.3 Product: spherical powder particles of lithium ferrous phosphate coated with carbon and having an average particle size distribution of D₅₀ of about 600-700 nm were obtained.

### EXAMPLE 2

2.1 Raw materials:

2.1.1 Spherical powder particles of lithium ferrous phosphate (LiFePO₄) having an average particle size of D₅₀ of about 300-400 nm, about 157 g, and

2.1.2 Glucose (C₆H₁₂O₆), about 7.6 g.

2.2 Preparation method:

2.2.1 Milling and mixing step: the carbon-containing compound was milled in a ball milling machine at a temperature of about −5° C., and then the lithium ferrous phosphate powder was added, milled and mixed for a time period of about 30 min while maintaining frozen, thereby forming a mixture thereof.

2.2.2 Heating, carbon coating and sintering step: the mixture was heated to a temperature of about 300° C. for a time period of about 5 hours in a vacuum environment to remove moisture and other liquid and gaseous impurities in the glucose. Then nitrogen was introduced, and the heated mixture is sintered at a temperature of about 800° C. for a time period of about 15 hours in a nitrogen atmosphere with a pressure controlled to be in the range of about 400-500 kPa to vaporize the carbon so as to coat carbon onto the surface of the lithium ferrous phosphate crystal.

2.2.3 Ball milling step: the cooled carbon-coated lithium ferrous phosphate powder was ball milled to disperse the agglomerated and caked particles.

2.3 Product: spherical powder particles of lithium ferrous phosphate coated with carbon and having an average particle size distribution of D₅₀ of about 400-500 nm were obtained.

### EXAMPLE 3

3.1 Raw materials:

3.1.1 Spherical powder particles of lithium ferrous phosphate (LiFePO₄) having an average particle size D₅₀ of about 150 to 200 nm, 157 g, and

3.1.2 Glucose (C₆H₁₂O₆), 11.5 g

3.2 Preparation method:

3.2.1 Milling and mixing step: the carbon-containing compound was milled in a ball milling machine at a temperature of about 0° C., and then the lithium ferrous phosphate powder was added, milled and mixed for a time period of about 60 minutes while maintaining frozen, thereby forming a mixture thereof.

3.2.2 Heating, carbon coating and sintering step: the mixture was heated to a temperature of about 300° C. for a time period of about 3 hours in a vacuum environment to remove moisture and other liquid and gaseous impurities in the glucose. Then nitrogen was introduced, and the heated mixture was sintered at a temperature of about 900° C. for a time period of about 20 hours under a nitrogen atmosphere with a pressure controlled to be in the range of 400-500 kPa to vaporize the carbon so as to coat carbon onto the surface of the lithium ferrous phosphate crystal.

3.2.3 Ball milling step: the cooled carbon-coated lithium ferrous phosphate powder was ball milled to disperse the agglomerated and caked particles.

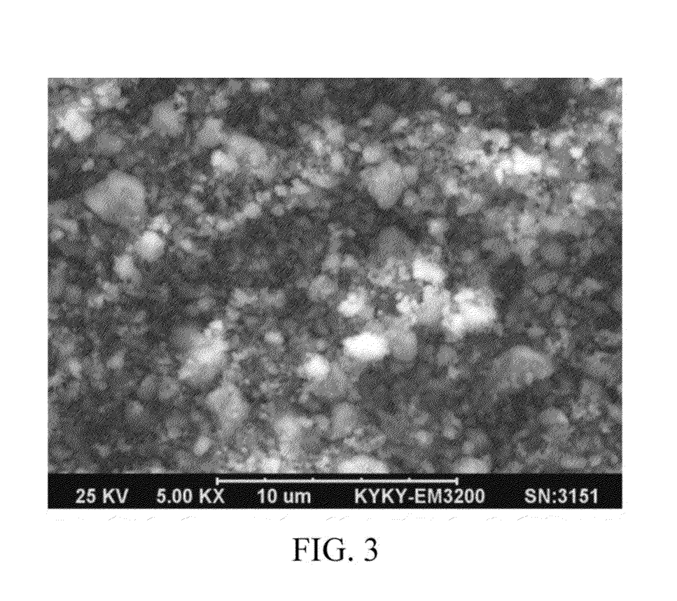

3.3 Product: spherical powder particles of lithium ferrous phosphate coated with carbon and having an average particle size distribution of D₅₀ of about 200 to 300 nm were obtained, as shown in FIGS. 2 and 3.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method of preparing a cathode material, comprising:
(a) providing particles of the cathode material; and
(b) coating a carbon layer onto the particles of the cathode material, wherein the carbon layer is originated from a carbon-containing compound.

2. The method according to claim 1, wherein the coating step comprises mixing the carbon-containing compound with the particles at a temperature equal to or lower than about 0° C.

3. The method according to claim 2, wherein the temperature is in a range of about −30° C.-0° C., and the particles are nano particles.

4. The method according to claim 3, wherein the carbon-containing compound is milled during or prior to the mixing step.

5. The method according to claim 4, wherein the coating step further comprises, subsequent to the mixing step, heating the nano particles and the carbon-containing compound at a temperature in a range of about 60-500° C. for a time period of about 2-8 hours in a vacuum environment.

6. The method according to claim 5, wherein the coating step further comprises, subsequent to the heating step, sintering the nano particles and the carbon-containing compound at a temperature in a range of about 500-1000° C. for a time period of about 4-24 hours in an inert atmosphere with a pressure in a range of about 400-500 kPa.

7. The method according to claim 6, further comprising: subsequent to the sintering step, milling the carbon-coated particles of the cathode material.

8. The method according to claim 7, wherein a mass percentage of the carbon of the carbon-containing compound in the cathode material is in a range of about 0.5%-5%.

9. The method according to claim 3, wherein the nano particles of the cathode material comprises lithium ferrous phosphate (LiFePO₄).

10. The method according to claim 1, wherein the carbon-containing compound has a chemical formula (CₓH_{2y}O_{y})ₙ, wherein n≧1.

11. The method according to claim 10, wherein n=1, y=6, and x=6.

12. A cathode material comprising nano particles coated with carbon, wherein a ratio of a size of the carbon-coated nano particles of the cathode material to a size of uncoated nano particles of the cathode material is in a range of about 1.01:1-1.5:1.

13. The cathode material according to claim 12, wherein the nano cathode material is LiFePO₄, and the ratio is in a range of about 1.01:1-1.30:1.

14. The cathode material according to claim 12, wherein shapes of the carbon-coated particles and the uncoated particles remain unchanged.

15. The cathode material according to claim 14, wherein the size, D₅₀, of the carbon-coated nano particles of the cathode material is in a range of about 500-700 nm; and the size D₅₀ of the uncoated nano particles of the cathode material is in a range of about 100-600 nm.

16. The cathode material according to claim 12, wherein the carbon is originated from glucose.

17. A method of preparing a cathode material, comprising:
(a) providing particles of the cathode material and a carbon-containing compound;
(b) milling and mixing the carbon-containing compound and the particles at a first temperature for a first period of time to form a mixture;
(c) heating the mixture at a second temperature for a second period of time in a vacuum environment;
(d) sintering the heated mixture at a third temperature for a third period of time in an inert atmosphere so as to vaporize the carbon of the carbon-containing compound, thereby coating the vaporized carbon on the particles to form carbon-coated particles; and
(e) milling the carbon-coated particles.

18. The method according to claim 17, wherein the milling and mixing step is performed by
(a) milling the carbon-containing compound;
(b) mixing the particles with the carbon-containing compound while milling the carbon-containing compound; and
(c) milling the mixed carbon-containing compound and particles.

19. The method according to claim 17, wherein the first temperature is in a range of about −30° C.-0° C., and the first period of time is about 0.2-1.5 hours, wherein the second temperature is in a range of about 60-500° C. and the second period of time is about 2-8 hours, and wherein the third temperature is in a range of about 500-1000° C. and the third period of time is about 4-24 hours.

20. The method according to claim 17, wherein the pressure in the inert atmosphere is in a range of about 400-500 kPa.

21. The method according to claim 17, wherein the particles of the cathode material comprises lithium ferrous phosphate (LiFePO₄).

22. The method according to claim 17, wherein the carbon-containing compound has a chemical formula (CₓH_{2y}O_{y})ₙ, wherein n≧1.

23. A cathode material prepared according to the method of claim 17.
